(19) United States
(12) Patent Application Publication
(10) Pub. No.: US 2002/0027541 A1
(43) Pub. Date: Mar. 7, 2002

(54) Driving arrangements for active matrix LCDs

(76) Inventors: Graham Andrew Cairns, Oxford (GB); Michael James Brownlow, Oxford (GB); Andrew Kay, Oxford (GB); Harry Garth Walton, Oxford (GB)

Correspondence Address: Neil A. DuChez, RENNER, OTTO, BOISSELLE & SKLAR, LLP, 1621 Euclid Avenue, 19th Floor, Cleveland, OH, 44115, US

(21) Appl. No.: 09/943,535

(22) Filed: Aug. 30, 2001

(30) Foreign Application Priority Data
Sep. 5, 2000 (GB) 0021712.5

(51) Int. Cl. G09G 3/36

(52) U.S. Cl. 345/87

(57) ABSTRACT

A driving arrangement for an active matrix liquid crystal display comprises: (a) a multi-format digital data driver arranged to operate in a plurality of different display modes, to receive digital input data in a plurality of different formats, and to drive data lines of the liquid crystal display so as to cause an image to be displayed in the display corresponding to said input data; and (b) data analysis means arranged to receive said digital input data, to determine the format of the input data, and to control the data driver to operate in the display mode corresponding to the format of the input data. There is provided a method of reducing power required to display a sequence of images on a liquid crystal display, in which images are analysed and if consecutive Images are substantially the same, then the liquid crystal display is not updated with the subsequent image.

### BACKGROUND OF THE INVENTION

1. Field of the Invention

A first aspect of the invention relates to driving arrangements. for active matrix liquid crystal displays (LCDs).

2. Description of the Related Art

FIG. 1 shows a typical Active Matrix Liquid Crystal Display (AMLCD) 2 comprising N rows and M columns of pixels 4. The boxes at the periphery of the matrix represent the display driver electronics, comprising a scan driver 6 with outputs connected to each row of pixel transistor gate electrodes (not shown), and a data driver with outputs connected to each column of pixel transistor source electrodes (not shown). The scan driver 6 and data driver 8 can be either analogue or digital, and can be implemented in IC technology or else monolithically using Thin Film Transistors.

In a typical AMLCD with digital drivers, an external LC controller IC supplies to the data driver a stream of digital image data, together with timing and control signals. the image data is usually clocked into an array of input registers in a line-sequential, fixed n-bit parallel RGB format, under the control of the data clock and the line (horizontal) synchronisation pulse. Once a line of n-bit RGB data has been read into the input registers, it is transferred into an array of n-bit storage registers. During the time that the subsequent line of input data is being sampled into the Input registers, the data in the storage registers is input to an array of n-bit Digital-to-Analogue Converters (DACs) in order to provide analogue voltages for driving the M data lines of the active matrix. The row-sequential outputs of the scan driver determine which of the N rows of pixel transistors is activated in order to receive the date on the data lines.

In a typical AMLCD with analogue drivers, the external controller IC supplies to the data driver an analogue video signal, together with timing and control signals. There are two main types of analogue data driver, referred to as line-at-a-time or point-at-a-time. In a line at a time data driver, one line of image data is read onto storage capacitors in the driver, before being applied to the active matrix through analogue buffers. Alternatively, in a point-at-a-time analogue driver, the video data is written directly to the data lines of the active matrix, through sampling transistors which are controlled by the timing generator of the driver.

An example of a typical LC controller IC 10 is shown in FIG. 2. The controller can take input video data in either luminance and chrominance format or RGB format, and supplies either analogue or digital gamma-corrected RGB to the LC data drivers of an active matrix display. On-screen display data, for example user-interface functions such as brightness etc., is supplied by the SRAM memory 12, and used to overwrite the video data in the display mixer circuit 14 shown.

From the above description of a standard fixed-format display, it is apparent that the power consumption of the data driver, the controller IC and the display is essentially constant. Typical sources of power consumption within the data driver and IC controller include the data sampling circuits, the distributed clock and timing signals and the DAC and amplifier circuits.

Within the field of mobile communication and information products, such as internet mobile phones and Personal Digital Assistants (PDAs), there is a need for displays which are capable of showing a variety of image formats whilst at the same time minimising power consumption. An example of such an application is illustrated in FIG. 3, which illustrates a conceptual mobile telephone handset capable of showing a variety of image formats, in accordance with the application that is running on the handset. Desirable image formats Include high quality video data or high-resolution colour text and video overlay through to low resolution standby graphics or low frame-rate text.

Standard digital data drivers and controllers, of the type described above can meet the requirements for driving an active matrix display with video and high-resolution colour graphics, with typically 6 to 8 bits per RGB and 60 Hz frame rates. However, this solution consumes unnecessary power in circumstances when the input image is of lower quality, for example with reduced colour resolution and/or frame-rate.

In order to overcome the above problem, and to support a plurality of input sources for overlay functions, the applicant has proposed a multi-format digital data driver 16 and active matrix display, as illustrated in FIG. 4. In this type of data driver, the mode of operation is controlled by simple Format Control Signals (SB, MB, NB and FRC). The format is selected in order to optimise the power consumption in accordance with the type of data to be displayed. Example operating modes are: monochrome, colour of various resolution (bit-plane) settings, 1 bit per colour data overlay (superimpose) function and reduced frame-rate driving.

The multi-format driver 16 takes standard clock and control signals and a plurality of image data inputs, for example a colour grey-scale input and a binary colour input. The grey-scale input, D(1:n+m), is a parallel input of n+m bit width, where m corresponds to the number of most significant data bits of the grey-scale and n to the number of least significant data bits of the grey-scale. The input is represented as D(1:n+m) because it contains bits 1 to n+m. This input supplies grey-scale pixel image data with one of two resolutions: high resolution where all n+m bits are read by the driver 16, and low resolution where only the m MSBs are read by the driver 16. The binary input, D, is a 1-bit input which supplies independent black/white pixel image data.

The operation mode of the multi-format driver 16, i.e. the driver format, is controlled by the format control signals, also indicated in the diagram. In the example shown, three Bit-Resolution Control (BRC) control signals, SB, MB and NB are supplied, together with a Frame Rate Control (FRC) signal. The bit-resolution signals are distributed where necessary to the components of the multi-format driver 16 so that a particular driver format can be enabled with the lowest possible power consumption.

FIG. 5 shows the trade off between the image quality and the power consumption, where it can be seen that the lowest power consumption is for one bit text data, and the highest power consumption is for n+m (e.g. 6 bit) video data with 1 bit overlay text.

The table in FIG. 6 shows an example of how three bit-resolution signals SB, MB and NB, can be used to select the five possible driver format modes shown in FIG. 5. Each control signal is responsible for enabling specific circuits within the multi-format driver 16, as shown in FIG. 7. SB enables the circuitry 18 associated with the single input data stream, D, which is used during the 1 bit display mode and when the overlay function is applied. MB enables the circuitry 20 associated with the most significant bits of the grey-scale input, D(n+1:n+m). NB enables the circuitry 22 associated with the least significant bits of the grey-scale input, D(1:n). In addition to the input signal combinations shown in the table, when all format control signals are 0, the miulti-format driver 16 is essentially off.

The variable resolution Digital-to-Analogue-Converter (DAC) 24, shown in FIG. 8, is used to convert the input data into analogue format suitable for driving the data lines of the panel. Parts of the circuit which are not used for a particular format, in particular the buffers during low-resolution mode, are disabled to reduce power consumption.

The frame rate control signal (FRC) can be used to enable circuitry for refreshing the active matrix display at slower update rates than the input frame rate. This can be particularly useful for saving power in situations where the input data is not changing, as for example in a static image.

### SUMMARY OF THE INVENTION

According to the first aspect of the invention there is provided a driving arrangement and active matrix display as set out in accompanying claims 1 to 16.

The invention thus allows the mode of operation of the display, and hence the power consumption and display quality, to be automatically controlled by the format of the input data itself. The operating mode and power consumption of the driver and display are optimised according to the data to be displayed. Therefore maximum battery life is obtained for portable equipment such as mobile communication terminals. The invention can be applied to a wide variety if integration technologies, such as Silicon IC display drivers or poly-Silicon monolithic drivers. The circuit overhead for the additional functionality is very modest, and hence there is a significant value-add for this type of display driver.

The invention can be implemented in the discreet controller IC, or else distributed within the driver ICs which can be connected to the active matrix by direct Chip On Glass (COG) bonding, or via flexible circuit connections. Alternatively, the circuits may even be integrated monolithically onto the same substrate as the active matrix devices, using Thin Film Transistor (TFT) technology such as high or low temperature poly-Silicon. The invention is particularly applicable to the control circuitry for mobile information displays, where power consumption is of prime importance.

A second aspect of the invention relates to power reduction in liquid crystal displays. More particularly, the invention relates to a method of reducing the power required to display a sequence of digital images on a liquid crystal display, and to hardware for implementing this method.

Sometimes liquid crystal displays are used to display images which may remain static, or substantially static, for a period of time. In the prior art this has resulted in energy being wasted by continuing to refresh the image at the same rate, even though the image is static. The invention reduces power consumption by reducing the rate at which the liquid crystal display is updated in such circumstances.

It is known to use a linear feedback shift register (LFSR) to generate an image signature, but not in the context of reducing the power consumption of a liquid crystal display.

U.S. Pat. No. 5,528,602 (West et al) describes use of a linear feedback shift register (therein referred to as an MISR) for determining the length of a stream of data corresponding to a video image to be displayed.

U.S. Pat. No. 3,976,864 (Gordon et al) describes a method for fault-testing digital apparatus. Digital words, derived from binary voltages arising at a point in the circuit under test, are fed into a suitably clocked feedback shift register. After a predetermined delay the register outputs a signature word, characteristic of the behaviour of the circuit. Two signatures, derived at different times, may be compared.

U.S. Pat. No. 5,862,150 (Lavelle et al.) describes use of an LFSR to generate an image signature.

According to the second aspect of the invention there is provided a method, a data analysis means, and a liquid crystal display device, as set out in accompanying claims 17 to 40.

### BRIEF DESCRIPTION OF THE DRAWINGS

Embodiments of the invention will now be described, by way of example only, with reference to the accompanying drawings, in which:

FIG. 1 shows a typical active matrix display with analogue or digital drivers;

FIG. 2 shows a typical active matrix display controller IC;

FIG. 3 shows a conceptual application of multiple format image data;

FIG. 4 shows a multi-format digital data driver;

FIG. 5 shows power consumption versus image quality for a multi-format display;

FIG. 6 shows a table of format control signals and selected display formats;

FIG. 7 shows the power control of the data sampling circuits of a multi-format driver;

FIG. 8 shows variable resolution digital to analogue conversion;

FIG. 9 shows an embodiment of the invention, achieving content driven display format control.

FIG. 10 shows the functional components of the data analysis means of FIG. 9;

FIG. 11 shows a generalised timing diagram for the data analysis means;

FIG. 12 shows an embodiment of the data analysis means used to generate bit-resolution control signals.

FIG. 13 shows a timing diagram for the bit-resolution control embodiment of FIG. 12;

FIG. 14 shows an embodiment of the data analysis means used to detect a static image and to output a Frame Rate Control Signal.

FIG. 15 shows a data analysis arrangement for analysing image data supplied to the data driver of a liquid crystal display;

FIG. 16 shows an active matrix liquid crystal display provided with data and scan drivers, and also with the data analysts arrangement of FIG. 15;

FIG. 17 shows a 4 stage linear feedback shift register (LFSR) suitable for use in the data analysis arrangement of FIG. 15;

FIG. 18 shows how additional logic gates can be added to the arrangement of FIG. 17 to allow the LFSR to produce a signature of a data set;

FIG. 19 shows the generation of sub-signatures for a first image; and

FIG. 20 shows the generation of sub-signatures for a second image which represents a translation of the first image by a distance of one pixel to the left.

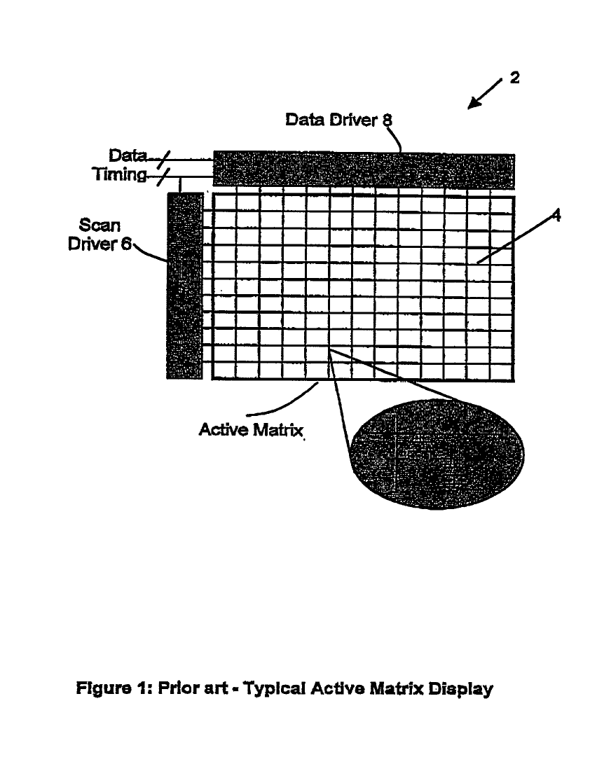

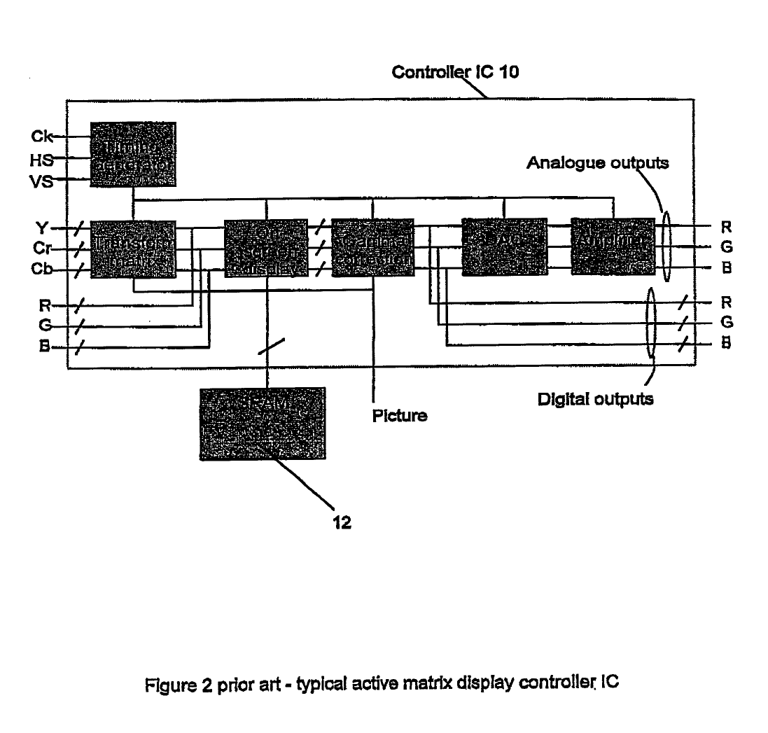

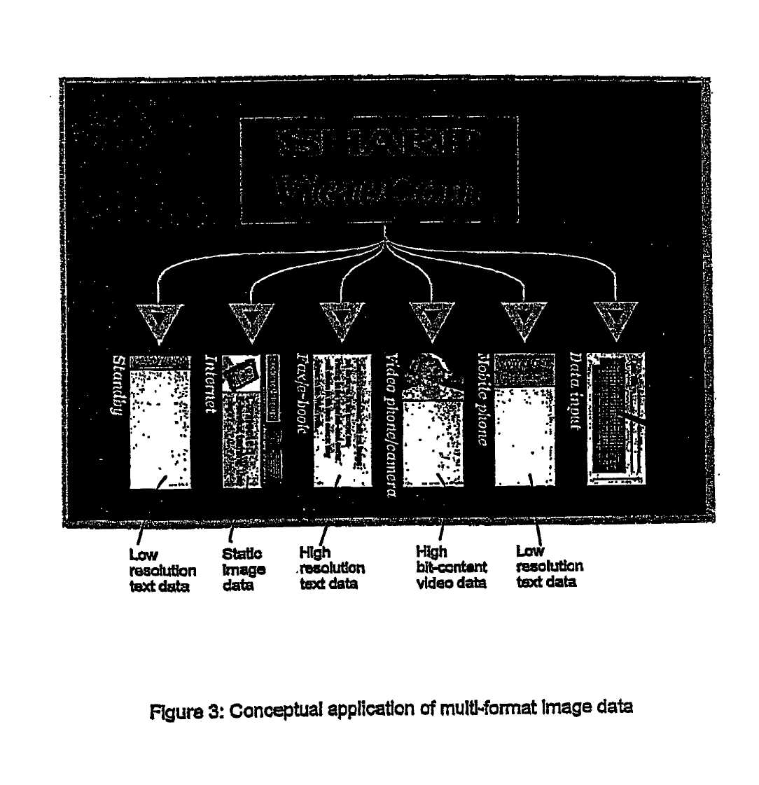

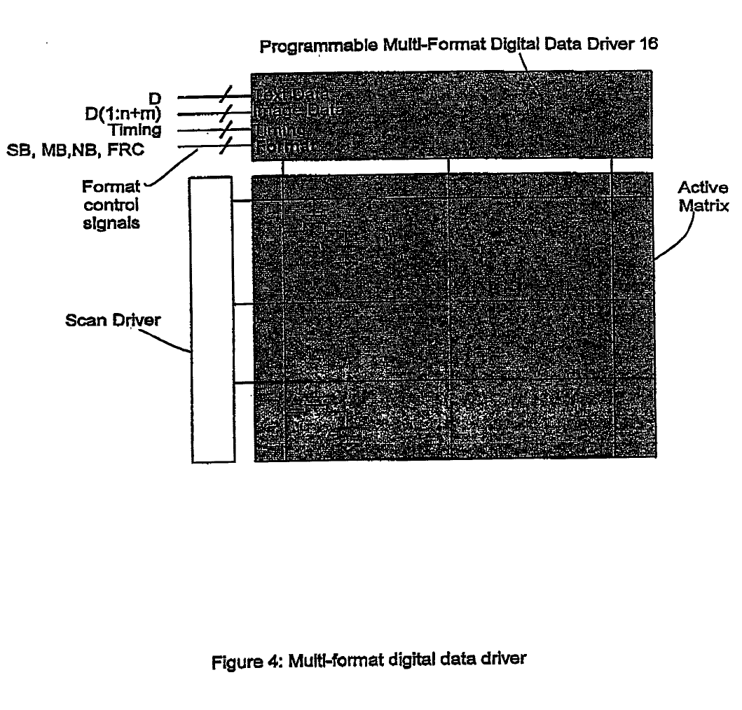

### DESCRIPTION OF THE PREFERRED EMBODIMENTS

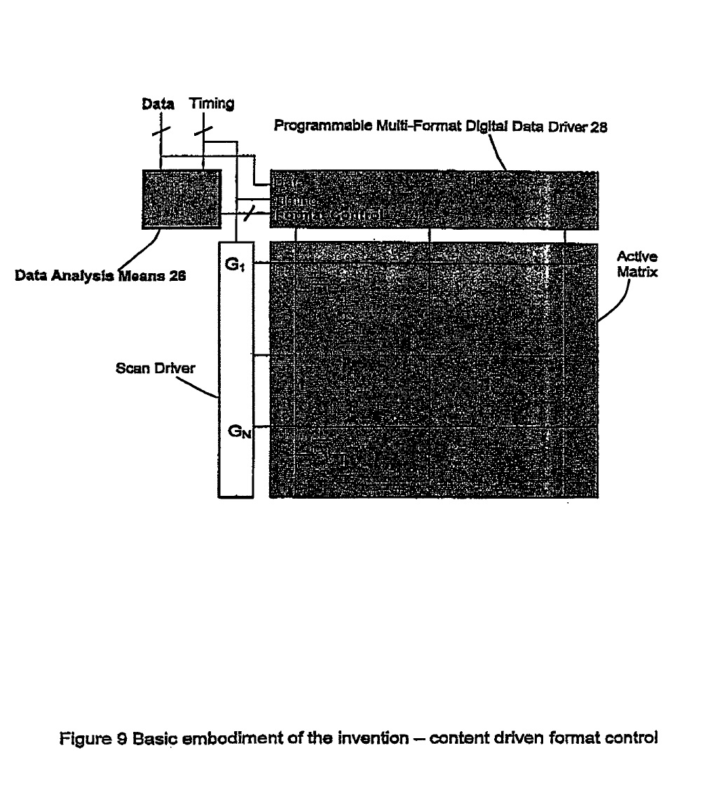

A simplified block diagram of an embodiment of the invention is shown in FIG. 9. A data analysis means 26 operates on input data, under the control of display timing signals in order to generate format control signals for a programmable multi-format digital data driver 28. The data analysts means 26 can be implemented remotely from the display driver 28, say within the LC controller (not shown), or it can be distributed within the data driver 28 itself.

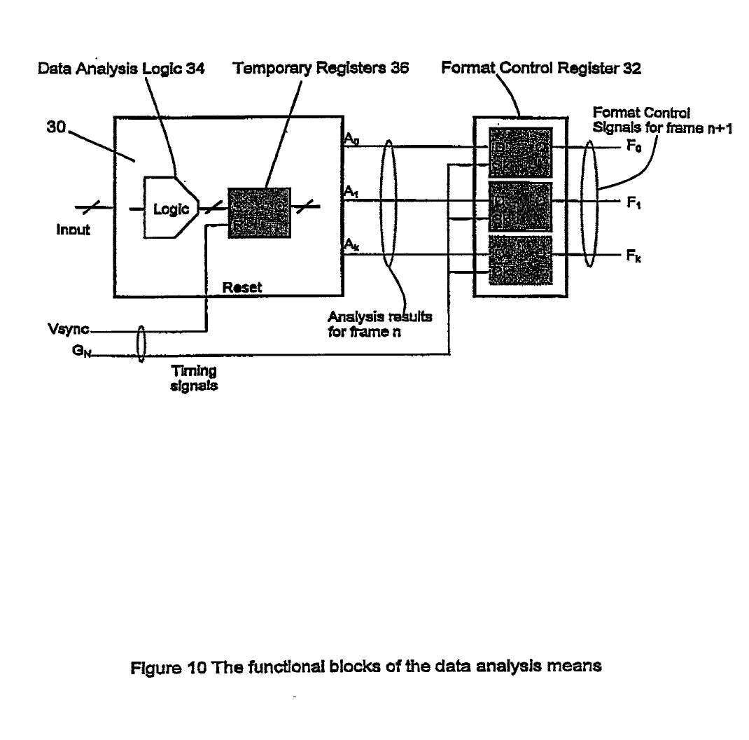

FIG. 10 shows a generalised view of the functional components within the data analysis means 26, which comprises two main functional units: a data analysis unit 30, and a format control register 32.

Within the data analysis unit 30 there exists an array of analysis logic blocks 34 which operate on the plurality of digital image data inputs during each frame of data. The logic blocks 34 can be simple combinational logic for detecting particular bit-sequences or bit-activities within the input data stream, or else they can be more complex functions such as adders or counters.

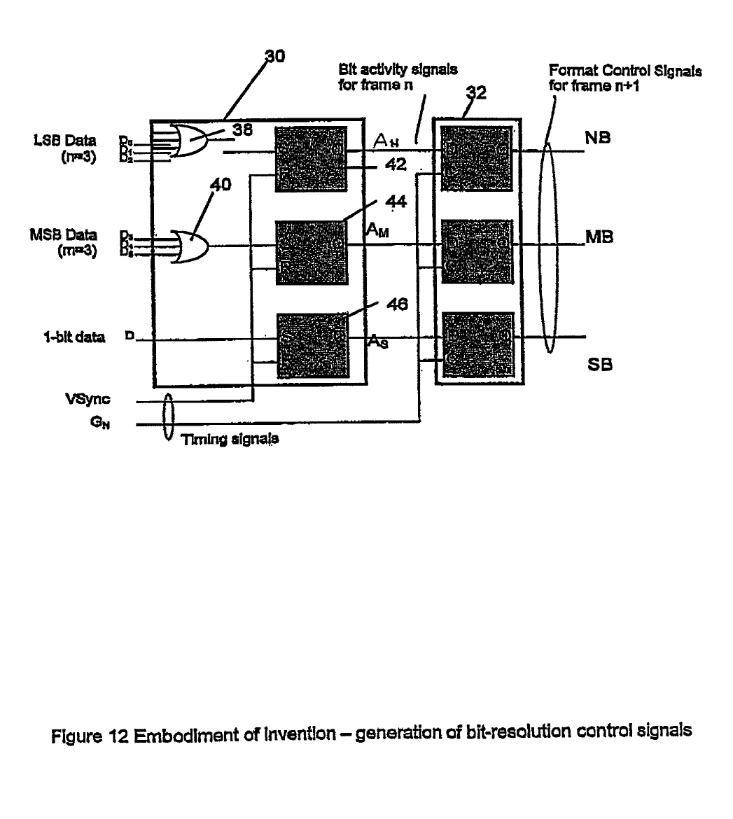

The outputs from the logic blocks 34 are latched in an array of temporary registers (represented by the SR block in FIG. 10, and FIG. 12 for example shows 3 such temporary registers), which are reset at the start of each frame of data, using for example the Vsync vertical synchronisation pulse. Each frame is made up of N lines, and a vertical and horizontal synchronisation pulse occurs at the beginning of each frame and line respectively.

At the end of the frame of data the analysis results for that frame are clocked out of the temporary registers. using for example the gate pulse from the last row of the scan driver, and stored in the Format Control Register 32. The outputs of the format control register 32 are used as the format control signals for the next frame of data.

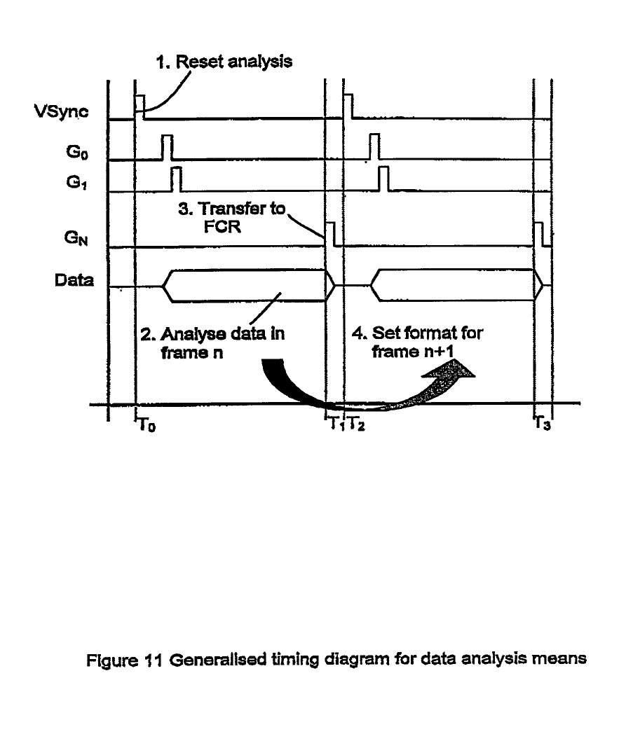

A generalised timing diagram for the data analysis means 26 is shown in FIG. 11. At time T₀ the temporary storage registers 36 are ‘reset’ by the Vsync signal, which indicates the beginning of a new frame of data. The data enters the data analysis means 26 and is also input directly to the display driver 28, which is pre-configured according to the format control signals derived from the previous frame.

As each new line of data is clocked into the data analysis means 26, the array of logic blocks 34 monitor the data for particular. activities or signature patterns, such as the number of bits, or the presence of text data etc. If a particular signature pattern is detected, the relevant logic block outputs a ‘high’ signal and the corresponding temporary storage registers 36 are ‘set’. At time T₁, the high signal from the scan driver pulse of row N, G_{N}, indicates that the last row of data has been read into the data analysis means 26 and the results from the temporary storage registers 36 are clocked into the array of format control registers 32.

During the time between T₁, and T₂, the format control signals are used to re-configure the multi-format digital data driver 28 for the next frame of data, into the optimum or lowest power configuration for data of the same type as that received during the current frame.

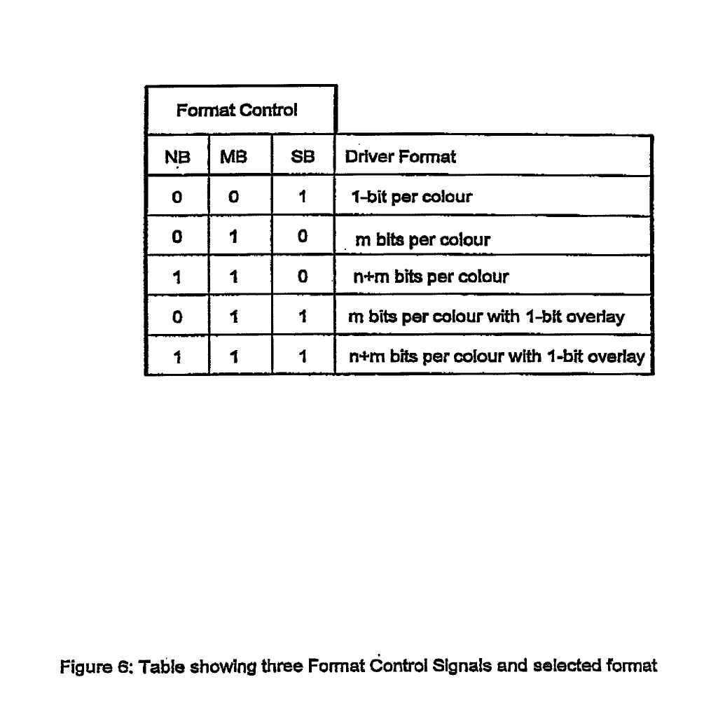

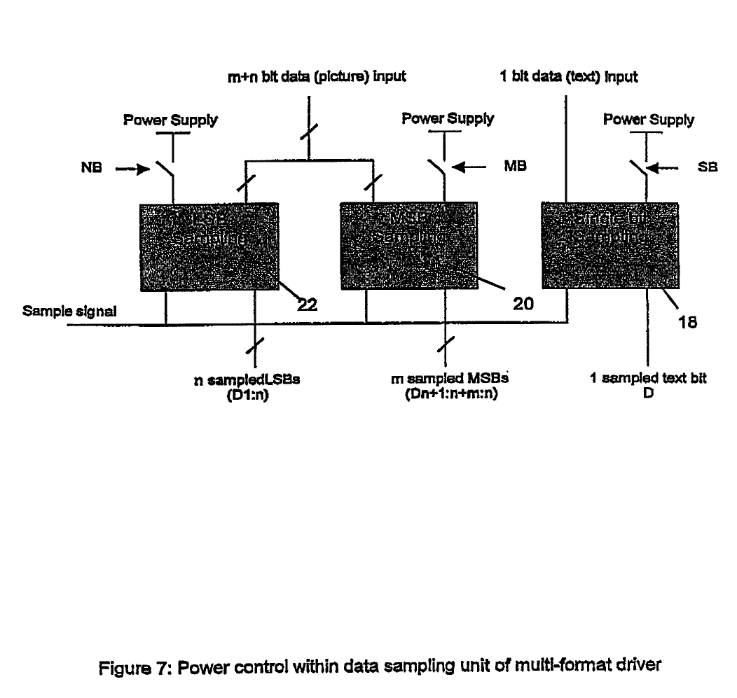

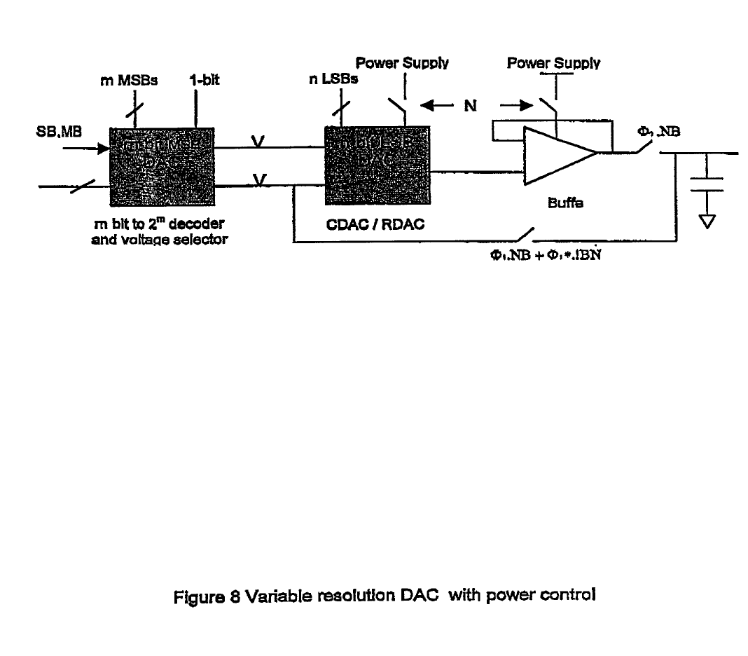

FIG. 12 shows an embodiment of the data analysis means 26 which is suitable for driving a multi-format digital data driver 28 with the format control signals shown in FIG. 6. In this simple embodiment there are two logic blocks 38, 40, three temporary storage registers 42, 44, 46 and three format control signals (NB, MB, SB) to control the bit resolution of the driver 28. During each frame of data, the ‘OR’ gates 38, 40 detect the presence of activity within any of the MSB image data inputs, the LSB image data inputs or else the text data input. If any activity is detected, the corresponding ‘SR latch’ (42, 44, 46) is ‘set’ and the activity signals A_{N}, A_{M} and A_{S} are transferred to the format control register 32 at the end of the frame.

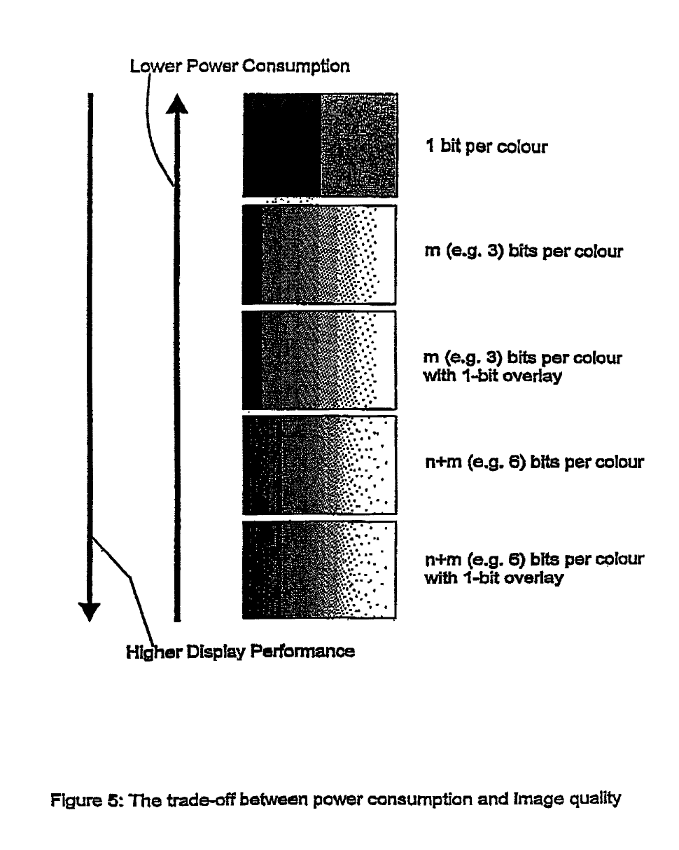

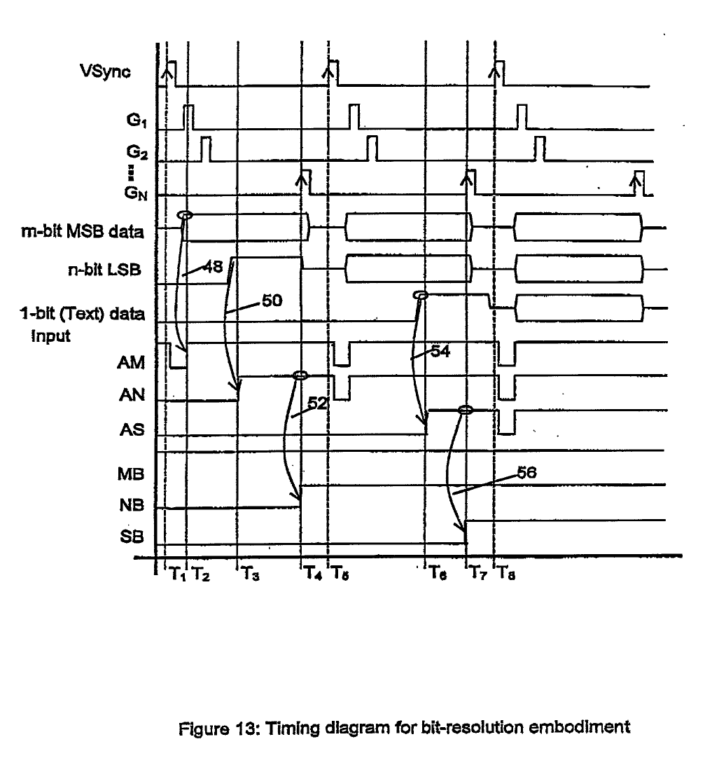

The timing diagram for this embodiment is shown in FIG. 13, for various data formats. At time T₁, all activity signals are reset to ‘low’ by the frame synchronisation pulse VSync and the format control signals MB, NB and SB remain at the values determined by the previous frame, with MB ‘high, and NB and SB ‘low’ i.e. the driver 28 is configured into m-bit mode. During the first frame of data, at time T₂, the MSB activity-signal A_{M} goes high immediately (as indicated by arrow 48), indicating that m-bit data is present. At time T₃, the data analysis means 26 detects activity in the LSB data as well as the MSB data, and so the activity-signal A_{N} goes high also (as indicated by arrow 50). At the end of the frame, all the activity signals are transferred into the format control register 32 at time T₄. Therefore, the driver 28 is configured into n+m bit mode at the beginning of the next frame also (as indicated by arrow 52). At time T₅ all the analysis signals are once again reset. At time T₆, the text analysis signal A_{S} also goes high (as indicated by arrow 54) so that for frame three the driver is configured into n+m bit mode, with 1-bit overlay also (as indicated by arrow 56), as illustrated in FIG. 5.

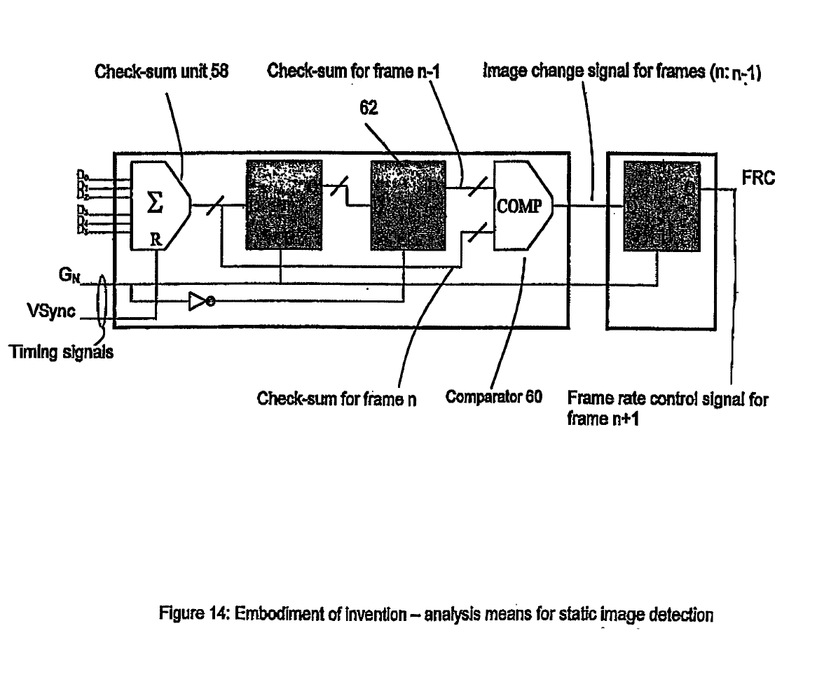

FIG. 14 shows an embodiment of the data analysis means 26 which is used to detect static image data and to output a format control signal which can be used by the multi-format driver 28 to disable the refresh of the liquid crystal, until such a time as is required by pixel leakage considerations. The basic operation of this embodiment is as follows.

At the heart of the analysis means 26 is a check-sum unit which is reset at the beginning of each frame of data and which performs a running addition of the input data within the frame. The output of the check-sum unit 58 is connected to a comparator 60 which compares the current check-sum with the check-sum from the previous frame. The comparator 60 outputs a ‘high’ logic level if the check-sum for the current frame, n, is the same as the check-sum for the previous frame n−1.

At the end of the frame n, the output from the comparator 60 is transferred to the format control register 32, and the check sum for frame n is transferred into a latch 62, ready to be compared with the check sum for the next frame of data.

Although the described embodiment updates the display mode of the data driver after every frame, other intervals are possible. For example, the data driven display mode could be updated after each line of input data is analysed.

Specific exemplary embodiments relating to a further aspect of the invention will now be described.

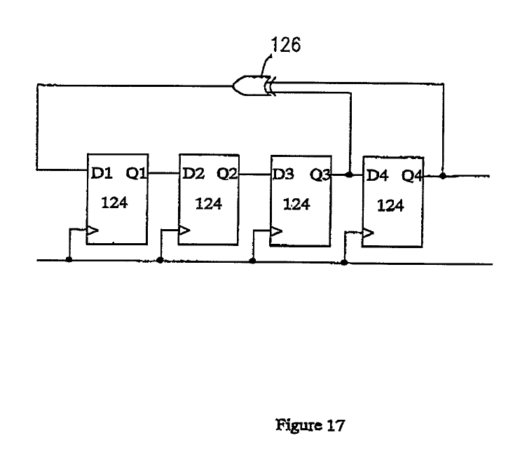

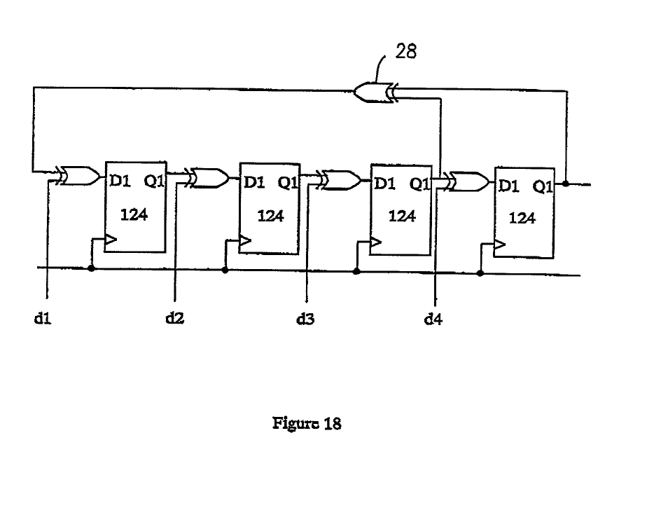

In the embodiment described here, a digital signature is generated by a linear feedback shift register (LFSR) described in more detail below with reference to FIGS. 17 and 18.

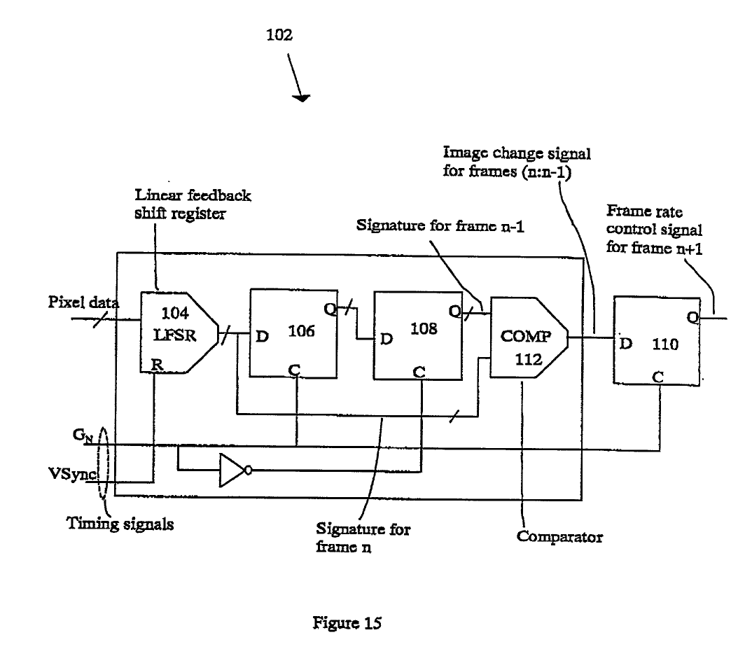

FIG. 15 shows a data analysis arrangement 102 which creates a signature (being a numerical value) for each frame of image data, and compares the signatures of successive frames to establish whether the frames have changed. If two successive signatures are found to be identical, then it is deemed likely that the display is showing a static scene, and the display is then set to “ignore” or “skip” (i.e. not update) one or more successive frames of image data. This allows the frequency at which information is updated on the LCD to be controlled in a manner which minimises power consumption by avoiding unnecessary refreshing of the LCD.

One way to compare two successive frames is to perform a simple bit count of all bits in the image. However, two images with the same bit count are not necessarily identical, and the use of an LFSR provides a more robust method of comparing successive images.

FIG. 15 shows a data analysis arrangement 102 which comprises a linear feedback shift register (LFSR) 104, latches 106, 108 and 110, and a comparator 112. The LFSR 104 produces a signature of each frame of data, and is reset at the beginning of each frame of data by a VSync signal. The output of the LFSR 104 is connected to the comparator 112, which compares the signature for the current frame with the signature stored by latch 108 from the previous frame. The comparator 112 outputs a “high” logic level if the signature for the current frame, n, is the same as. that for the previous frame, n−1.

At the end of each frame, the output from the comparator 112 is transferred to latch 110, and used to provide a frame rate control signal for the next frame.

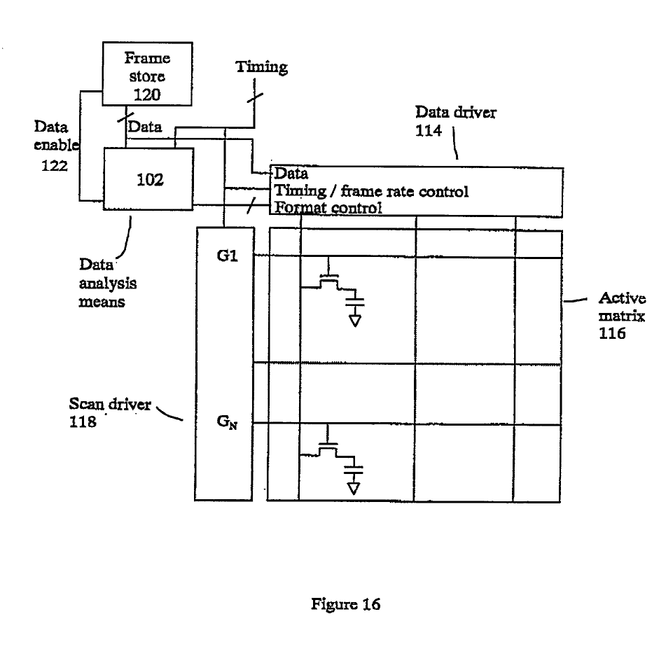

FIG. 16 shows how the data analysis arrangement 102 provides control signals to the data driver 114 of an active matrix liquid crystal display 116, which is also provided with a scan driver 118. The data analysis arrangement 102 receives image data from a frame store 120, and may also provide a control signal back to the frame store 120, as described in greater detail below.

In the embodiment described here, the frame of image data may be divided into more than one part with separate signatures generated for each part. For example, image data corresponding to a first image filling the upper half of a display screen is used to form a first signature (‘1u’). Data corresponding to the lower half of the screen is used to form a second signature (‘1d’) for the first frame. These signatures may then be compared with those derived for a second frame (‘2u’) and (‘2d’), and the two halves of the screen updated according to a result of these comparisons. For example, a set of static icons might appear in the upper half of a screen whilst a moving graphic appears in the lower half of a screen. In this event 1u and 2u will be identical, whilst 1d and 2d will differ. The lower half of the screen might then be updated in both frames one and two, whilst updating of the upper half of the screen might be disabled for some number of subsequent frames. It is clear that this process can be extended to allow for multiple signatures corresponding to multiple areas on a display. The positioning, size and or number of areas chosen for frame-to-frame comparison might vary over time.

Furthermore, not all bits used to set the brightness level of a pixel have to be used in forming the signature of an image. For example consider an 8-bit image. Each RGB sub-pixel of a display may then show any of 2⁸−1(=255) brightness levels. The 8-bits corresponding to a brightness level may be grouped into higher and lower order parts (most significant bits (MSB's) and least significant bits (LSB's)) with, for example, the difference between brightness states corresponding to a change in the highest MSB (for example the two states 10000000 and 00000000) being large, whilst the brightness difference arising as a result of a change of LSB (00000001 and 00000000) may be very slight. In forming a signature of an image it may be sufficient to use only a subset of the bits (for example only the 7 highest bits) for each pixel i.e. it may be sufficient to treat two images as identical (i.e. have them give rise to identical signatures) in the event that differences occur only in one or more LSB's.

In the embodiment described here, in the event that the signatures of two frames are equal it is desirable (in order to save power) to inhibit both the updating of pixels on the active matrix liquid crystal display 116, and also to inhibit the original writing-out of data from the frame store (or frame buffer) 120.

FIG. 16 shows this feature. Here the data analysis arrangement 102 controls both the timing on-panel (i.e. frame rate) and also (via a data enable line 122) whether data is written out by the frame store 120 (also termed a ‘frame buffer’ or VRAM in the literature) to begin with.

FIG. 17 shows an example four-stage LFSR 104. The register consists of four DQ flip-flops 124. At an appropriate clock signal (for example a rising edge) on a clock signal line 25, the input voltage bit present at the D input of each flip-flop 124 is clocked through to the respective Q output where it is held until the next clock signal. The voltages present at the register output (Q4) and a so-called ‘tap-point’ (here Q3) form inputs for an XOR logic gate 126. The output of XOR gate 126 is fed-back to the input (D1) of the register.

The consequence of this feedback arrangement is that the four voltage bits (which together can be taken to constitute a 4-bit digital word) at Q1-Q4 are caused to cycle through a pseudo-random sequence i.e. a sequence of 4-bit words which, although deterministic, presents no obvious pattern of change. For example, if we suppose that at an initial time Q1-Q4 hold the 4-bit word ‘1111’ (typically the LFSR 104 will be provided with additional circuitry—not shown—to allow it to be preset to an initial state as will be well known by those skilled in the art), then the following sequence of words is generated by repeatedly clocking the shift register:

1111

0111

0011

0001

1000

0100

0010

1001

1100

0110

1011

0101

1010

1101

1110

After passing through these fifteen states the register returns to state ‘1111’. A 4-stage LFSR with a tap at Q3 is a maximum length LFSR in that it cycles through the largest number of distinct states before repetition of a state. A maximal length LFSR with a given number of stages may require multiple tap-points. Tap points for maximal length LFSR's have been tabulated in the literature. For example an 18-stage LPSR with tap point at Q11 will cycle through 262143 distinct states in pseudo-random fashion. It can be preferable to choose LFSR's with tap points producing maximum cycle length, however the invention is not restricted to such choices and other tap points can be chosen.

As shown in FIG. 18, additional logic gates (for example XOR gates 28) can be used to allow a signature of a data set to be processed by an LFSR. FIG. 18 shows an example of the input of a 4-bit word d(1:4) into a 4-stage LFSR (in general the LFSR may have more stages than d-inputs). If the LFSR initially contains the word Q1-Q4=‘1111’ and if at all times d(1:4)=‘0000’, then the register will simply repeat the fifteen-word cycle listed above. In general however, if word d(1:4) alters between clock cycles, then this will impact upon the sequence of states of the LFSR. For example, two identical LFSR's, loaded with an identical initial state (for example Q1-Q4=‘1111’), and clocked repeatedly with however inputs d(1:4) varying differently for the two LFSR's, will in general store different words Q1-Q4 after a large number of clock cycles. Word Q1-Q4 will then be a ‘signature’ of the history of the sequence of inputs inputs (d1:4), two differing sequences of d(1:4) inputs leading in general to differing signatures Q1-Q4.

In this embodiment, the ‘d’ input data is digital data corresponding to an image to be displayed on the active matrix LCD 116. A digital signature is formed for the image by consecutively clocking the digital words (which correspond to the brightness level of each pixel) comprising the image into the LFSR 104, with a signature of the image being read out after all pixel data in the image has been processed.

For example, in a 6-bit display system each red, green and blue (RGB) sub-pixel of the display has its brightness set by a 6-bit word. Equivalently, the colour of each RGB pixel triad is set by an 18-bit word. A signature of a full frame of image data can be formed by consecutively clocking all 18 bit pixel words into an LFSR having e.g. 18 stages. if the screen comprises e.g. 307200 pixels (VGA resolution), then in total the LPSR will receive 18×307200 bits of data, after which it will be left in one of 2¹⁸−1 possible states, the actual state constituting the signature for that image.

The pseudo-random nature of an LFSR is such that, should two frames of data differ by even a single bit, then it is extremely probable that the signatures of these frames will be different. This provides a more reliable outcome than simply arithmetically adding each pixel word value, since two images, one with, for example a cursor icon in one portion of a screen, the second with the cursor having moved, may give the same arithmetic checksum despite being different images.

It some situations, it may also be advantageous to regard two images as identical in the event that the images are identical but merely spatially translated versions of one another. For example a static scene may be viewed with a digital camera subject to a small amount of camera shake. A given element of the scene may correspond to a given pixel of a display at one instance. In a subsequent frame the scene element might be caused to correspond with an adjacent pixel due, for example, to some small camera-shake. It may be advantageous to treat two such consecutive images as identical. This may be achieved by using two or more signatures per each frame of image data as will be understood with reference to FIGS. 5 and 6.

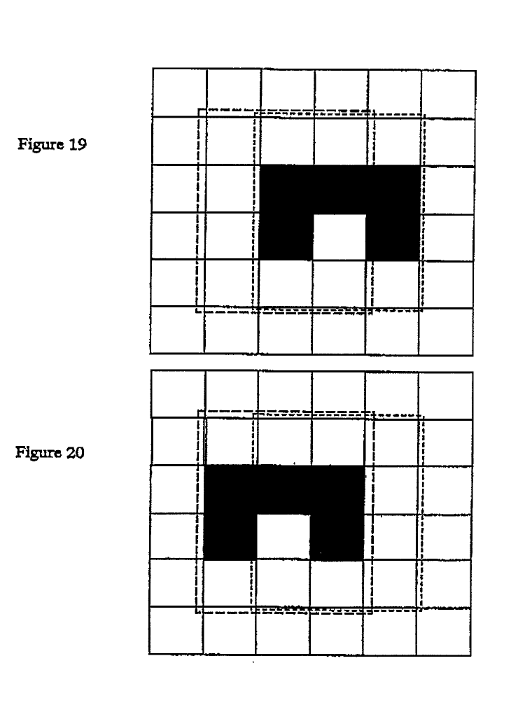

FIG. 19 represents an image frame displayed on an LCD consisting of a 6×6 array of pixels (in practice a high quality display may have, for example, more than 100,000 pixels). FIG. 20 shows a subsequent frame of data. It is clear in this example that the image has suffered a translation of one pixel, but is otherwise identical. It may be the case that these images are intended to be Identical, with the translation having arisen only as a result, for example, of inadvertent camera shake at the image source. Two LFSR's (or one suitably time-multiplexed LPSR) may be used to detect translation of an otherwise unchanging image.

We consider forming a signature (or “sub-signature”) ‘A1’ of the pixel data for all pixels entirely falling within line ‘A’ in the first frame (shown in FIG. 18). A second signature ‘B1’ is also formed for pixel data for all pixels entirely falling within line ‘B’ in the first frame (FIG. 19). This process is repeated in the next frame (FIG. 20) to form corresponding signatures ‘A2’ and ‘B2’. Signatures A1 and B1 are then compared with A2 and B2. It will be clear from the positioning of regions A and B, that signatures A1 and B2 will be identical. Therefore by the steps of

1. Forming a signature in each of two frames, for each of two regions, translated by a distance of one pixel, and

2. Comparing the signatures in frame n with those of frame n+1

situations in which an image has beem merely translated without changing may be identified.

In FIGS. 19, 20 the regions of LFSR signature analysis permit only right-going translations by one pixel distance to be detected. It will be clear that the generation of for example, eight signatures per frame, corresponding to eight suitably arranged areas A,B,C, will permit detection of a simple translation of an otherwise unchanging image in any of the up, down, left, right and four diagonal directions. Equally, simple translations of more than a single pixel distance may be detected by similarly forming appropriate multiple signatures corresponding to appropriate pixel regions.

It will be noted in FIGS. 19 and 20 that those pixels at the edge of the image are not included in the generation of an image signature. This can be beneficial, for example, in the case that the image translation arises as a consequence of camera judder, where for example, a movement of the camera may bring new elements of a scene into view. This may cause those pixels along the edge of the display to then receive new data, although the rest of the image is otherwise unchanged. It can thus be beneficial to exclude data corresponding to a layer of one or more pixels at the edge of the display when forming signatures in this embodiment.

It is well known to DC balance a liquid crystal display. In operation, a liquid crystal pixel has a voltage developed across it. The voltage is defined between a pixel electrode on one substrate of the LCD and a counter plane electrode on the other substrate. Opposite polarities result in identical brightness levels for the pixels since common LCD's are insensitive to voltage polarity. Nevertheless, it is found to be beneficial to alternate the polarity of voltage applied to liquid crystal pixels over time, to avoid problems such as drift of ionic impurities in the pixel which can degrade image performance.

In a simple exemplary DC balance scheme, if all pixels are to show a brightness corresponding to a 3V data state for two consecutive frames, then in a first frame all pixels may be switched to +3V and in the next frame −3V.

It will be appreciated that a decision to not update a frame of data could interfere with DC balance. Consider an image which remains identical for many successive frames, and consider an embodiment of the current invention in which a third, sixth, ninth etc. frames are accordingly not updated on the display. We consider a simple DC balance scheme in which all pixels receive the same polarity (either positive or negative) data in any one frame time. In a first frame we suppose all pixels receive positive voltage data. To ensure DC balance, in the second frame all pixels then receive negative voltage data. Since the third frame in not updated however, this results in the pixels retaining negative voltage data for the entirety of frames two and three.

In this embodiment, the system is arranged so that after not updating frames, the same polarity is used for subsequent frames as has been used during the non-updated frames, so that DC balance is retained over time.

In the case of the current example therefore, frame four is again updated with negative voltage data (since three was not updated and was negative). DC balance then continues as normal with frame five updated with positive data. Frame six is not updated, and therefore all pixels retain the positive voltage data applied in frame five. Frame seven is updated with positive voltage data since frame six was not updated and was positive, etc.

It will be seen that in this manner DC balance is retained over time, since, over a long time period, pixels are driven with positive polarity data as often as with negative polarity data.

More complex DC balance schemes exist. For example ‘row inversion schemes’ in which all even numbered rows may receive positive voltage data in an nth frame whilst all odd numbered rows receive negative voltage data in the same frame. In the (n+1)th frame these polarities are reversed. In this case the above embodiment is still applicable. It is only necessary that a record (for example a 1 bit flag) be kept to determine whether, in a previous frame, whether all the even rows received positive or negative data. This same pattern of row polarity is then applied in the first frame to be updated following a period in which the image was not updated.

What is claimed is:

1. A driving arrangement for an active matrix liquid crystal display comprising:
(a) a multi-format digital data driver arranged to operate in a plurality of different display modes, to receive digital input data in a plurality of different formats, and to drive data lines of the liquid crystal display so as to cause an image to be displayed by the display corresponding to said input data; and
(b) data analysis means arranged to receive said digital input data, to determine the format of the input data, and to control the data driver to operate in the display mode corresponding to the format of the input data.

2. A driving arrangement as claimed in claim 1, wherein the data analysis means forms part of the data driver.

3. A driving arrangement as claimed in claim 1, wherein the data driver is arranged to consume less power in low resolution display modes compared to high resolution display modes.

4. A driving arrangement as claimed in claim 1, wherein said display modes include at least one 1-bit overlay mode.

5. A driving arrangement as claimed in claim 1, wherein the data analysis means analyses each frame of input data in turn, and updates the mode of the data driver at the end of each frame.

6. A driving arrangement as claimed in claim 1, wherein the data analysis means comprises frame comparison means for comparing each frame of input data with the next, and for determining if the input data for a number of consecutive frames is the same.

7. A driving arrangement as claimed in claim 6, wherein the data driver is arranged to operate at more than one refresh rate, and wherein the data analysis means is arranged to control the data driver to operate at a lower refresh rate if the comparison means determines that the input data has remained unchanged for a number of frames.

8. A driving arrangement as claimed in claim 1, wherein the data analysis means comprises a plurality of inputs each arranged to receive a single bit of said digital input data, and wherein at least some of said inputs are connected to a logic OR gate arranged to detect activity on one or more of said at least some inputs.

9. A driving arrangement as claimed in claim 1, wherein the data analysis means is arranged to supply format control signals to the data driver in order to control the display mode of the data driver.

10. A driving arrangement as claimed in claim 9, wherein said format control signals include at least high and low resolution control signals.

11. A driving arrangement as claimed in claim 1, wherein the data driver comprises a plurality of variable bit resolution digital to analogue converters.

12. A driving arrangement as claimed in claim 1, wherein the data driver comprises a plurality of digital data input channels arranged to receive said digital input data.

13. A driving arrangement as claimed in claim 1, wherein the data analysis means comprises a number of storage registers.

14. An active matrix liquid crystal display comprising a driving arrangement as claimed in claim 1.

15. An active matrix liquid crystal display as claimed in claim 14, wherein the driving arrangement is integrated monolithically onto the same substrate as the thin film transistors of the active matrix.

16. An active matrix liquid crystal display as claimed in claim 15, wherein said thin film transistors are poly-silicon.

17. A method of reducing the power required to display a sequence of images on a liquid crystal display, comprising the steps of:
analysing the image data representing each image,
comparing the image data for the current image with that for the previous image,
from the comparison of the previous step, determining whether the two images are the same, or substantially the same,
if the images are the same, or substantially the same, then not updating the liquid crystal display with at least the subsequent image, in order to reduce the power consumption of the liquid crystal display.

18. A method as claimed in claim 17, wherein if said two images are determined to be the same, or substantially the same, then the liquid crystal display is prevented from being updated by more than one subsequent image.

19. A method as claimed in claim 17, wherein the step of analysing the image data for each image involves producing a signature for each image.

20. A method as claimed in claim 19, wherein said signature is the sum of all data bits representing the image.

21. A method as claimed in claim 19, wherein said signature is more complex than a simple sum, and takes into account the sequence of data bits representing the image.

22. A method as claimed in claim 21, wherein said signature is produced using a linear feedback shift register.

23. A method as claimed in claim 19, wherein at least some of the bits representing the brightness level of each pixel are ignored when producing said signature.

24. A method as claimed in claim 23, wherein the bit or bits which are ignored are the least significant bit or bits.

25. A method as claimed in claim 17, wherein said sequence of digital images occupy only a part of said liquid crystal display.

26. A method as claimed in claim 25, wherein said liquid crystal display is divided into a plurality of regions, and the steps of the method are carried out separately for each region, so that if the current and previous images for a given region are determined to be the same, or substantially the same, then that region is not updated with at least the subsequent image, or portion of an image, for that region.

27. A method as claimed in claim 17, wherein if it is determined that the liquid crystal display, or a portion thereof, is not to be updated, a first control signal is sent to a data driver associated with the liquid crystal display, said first control signal preventing the liquid crystal display, or a portion thereof, from being updated.

28. A method as claimed in claim 17. wherein if it is determined that the liquid crystal display, or a portion thereof, is not to be updated, a second control signal is sent to a frame store associated with the liquid crystal display, said second control signal preventing image data from being written out of said frame store.

29. A method as claimed in claim 17, wherein in the step of determining whether said two images are the same, or substantially the same, said two images are considered to be substantially the same if the current image represents a translation, or substantially a translation, of the previous image.

30. A method as claimed in claim 29, wherein said step of analysing the image data includes:
producing a first sub-signature for a first region of a first image, and
producing a second sub-signature for a second region of the first image, wherein said first region of the first image corresponds to a translation of said second region of the first image by one or more pixels, and
producing a first sub-signature for a first region of the subsequent image, and
producing a second sub-signature for a second region of the subsequent image, wherein said first region of the subsequent image corresponds to a translation of said second region of the subsequent image by one or more pixels, and
comparing said first and second sub-signatures for the first image with said first and second sub-signatures for the subsequent image, to determine whether the subsequent image represents a translation, or substantially a translation, or the first image.

31. A method as claimed in claim 30, wherein each sub-signature is produced using a linear feedback shift register.

32. A method as claimed in claim 30, wherein at least 8 sub-signatures are produced for each of said first and subsequent images, said sub-signatures corresponding to translations in different directions.

33. A method as claimed in claim 30, wherein said first and second regions of the first and subsequent images do not include any pixels which lie adjacent an edge of the images.

34. A method as claimed in claim 17, wherein said liquid crystal display is DC balanced, and wherein if the liquid crystal display is not updated, the polarity applied to pixels in subsequent frames is such that DC balance is retained over time.

35. A method as claimed in claim 34, wherein if the liquid crystal display is not updated for one or more frames, then the polarity, or polarities, applied to pixels on the first subsequent frame which is updated is or are the same as the polarity or polarities existing during said one or more frames.

36. Data analysis means arranged to carry out the method of claim 17.

37. Data analysis means as claimed in claim 36, which comprises a linear feedback shift register.

38. Data analysis means as claimed in claim 36, which further comprises a first control output arranged to provide a first control signal to a data driver, wherein if it is determined that the liquid crystal display, or a portion thereof , is not to be updated, said first control signal is sent to said data driver associated with the liquid crystal display, said first control signal preventing the liquid crystal display, or a portion thereof, from being updated.

39. Data analysis means as claimed in claim 36, which further comprises a second control output arranged to provide a second control signal to a frame store, wherein if it is determined that the liquid crystal display, or a portion thereof, is not to be updated, said second control signal is sent to said frame store associated with the liquid crystal display, said second control signal preventing image data from being written out of said frame store.

40. A liquid crystal display device comprising a liquid crystal display, a data driver, and a data analysis means as claimed in claim 36.
